(19) United States
(12) Patent Application Publication
(10) Pub. No.: US 2017/0210067 A1
(43) Pub. Date: Jul. 27, 2017

(54) SYSTEM AND METHOD FOR INTEGRATED RAILS

(71) Applicant: TIKO 3D LTD., Oshawa (CA)

(72) Inventor: Mateusz Jan Gajkowski, Mississauga (CA)

(73) Assignee: TIKO 3D LTD., Oshawa (CA)

(21) Appl. No.: 15/327,921

(22) PCT Filed: Jul. 24, 2015
(86) PCT No.: PCT/CA2015/000443

§ 371 Date: Jan. 20, 2017

Related U.S. Application Data
(60) Provisional application No. 62/028,530, filed on Jul. 24, 2014.

(51) Int. Cl. B29C 67/00; B29C 47/20; B33Y 50/02; B33Y 30/00; B29C 47/00

(52) U.S. Cl. CPC B29C 67/0055; B33Y 30/00; B29C 47/0023; B29C 67/0088; B33Y 50/02; B29C 47/20; B29K 2027/06

(57) ABSTRACT

Apparatuses, dies and methods for manufacturing are provided a body configured as a housing for a three-dimensional printer. An apparatus is provided including a body configured as a housing for a three-dimensional printer; three or more rails integrally formed on the body; wherein the three or more rails are oriented and positioned such that the three or more rails are configurable for co-operation with three or more drive systems, the three or more drive systems being attachable to three or more arms connected to an end effector; and wherein the movement of the three or more arms are balanced such that the aggregate motion contributed by each of the three or more arms provide sufficiently accurate movement of the end effector as the end effector undergoes translational movement in three-dimensional space.

### CROSS-REFERENCE TO RELATED APPLICATIONS

This application is a non-provisional of U.S. provisional application 62/028,530, entitled “SYSTEM AND METHOD FOR INTEGRATED RAILS” and claims all benefit, including priority of the provisional application, incorporated herein by reference.

### FIELD

The disclosure relates generally to bodies having rails, and more particularly to apparatuses, dies, and methods for manufacturing bodies with integrally formed rails.

### BACKGROUND

There are a number of mechanical designs utilized in products, and/or manufacturing equipment in various industries that require the use of a plurality of rails.

### SUMMARY

The present disclosure relates to apparatuses, dies, and methods for manufacturing bodies with integrally formed rails, according to some embodiments.

In a first aspect, an apparatus is provided comprising: a body configured as a housing for a three-dimensional printer; three or more rails integrally formed on the body; wherein the three or more rails are oriented and positioned such that the three or more rails are configurable for co-operation with three or more drive systems, the three or more drive systems being attachable to three or more arms connected to an end effector; wherein the movement of the three or more arms are balanced such that the aggregate motion contributed by each of the three or more arms provide sufficiently accurate movement of the end effector as the end effector undergoes translational movement in three-dimensional space, and the three or more arms are configured for traversing the three or more rails to cause the end effector to undergo translational motion in relation to the body, the end effector configured for extruding a filament used in the formation of a three-dimensional object formed through the extrusion of the filament as the end effector undergoes the translational motion in accordance with one or more electronic instructions; and wherein the three or more rails are integrally formed on the body through extrusion as a single, unibody unit, the three or more rails being integrally oriented and positioned relative to the body during the manufacturing of the apparatus such that an end user is able to adapt the housing for use with three-dimensional printing without the end user undertaking additional steps of calibrating the three or more rails.

In another aspect, a control unit is provided, the control unit configured for controlling the operation of the three or more drive systems and the operation of the end effector in accordance with the one or more electronic instructions.

In another aspect, the end effector further includes an accelerometer, the accelerometer configured to capture sensory data used at least for increasing calibration of the translational motion of the end effector.

In another aspect, the three or more rails are configured to support the three or more arms projecting downwards from the three or more rails, suspending the end effector in positions below the three or more rails.

In another aspect, the three or more drive systems are configured for cooperation with three or more linear bearings.

In another aspect, the three or more drive systems are configured for cooperation with three or more roller bearings, each one of the three or more roller bearings having one or more grooves.

In another aspect, the three or more rails face towards the center of the body.

In another aspect, the three or more rails face radially outwards relative to the center of the body.

In another aspect, the three or more rails have equal lengths.

In another aspect, the three or more rails are substantially aligned in the same direction.

In another aspect, the three or more rails are equally spaced around the circumference of the body.

In another aspect, the body is substantially cylindrical.

In another aspect, the body is substantially triangular.

In another aspect, the body only includes three rails.

In another aspect, the three rails spaced equidistant to one another.

In another aspect, the body and the rails are formed with a polymer.

In another aspect, the body and the rails are formed with a metal or metal alloy.

In another aspect, each rail of the three or more rails includes a toothed belt.

In another aspect, each toothed belt is secured to the inside of a corresponding rail using a fastener.

In another aspect, each toothed belt includes at least materials having noise and vibration dampening properties.

In another aspect, each rail of the three or more rails includes an integrated toothed tab.

In another aspect, the integrated toothed tab is configured to be utilized as a gear rack for interconnection with a pinion gear, providing a rack and pinion drive system along which the drive systems may be configured to traverse along the three or more rails.

In another aspect, a method for manufacturing an apparatus with two or more rails integrally formed on a body is provided, the method comprising: receiving a powdered mix including at least PVC plastic, pigments, and strengthening additives; pelletizing the mix; melting the mix to form a molten mix; forcing the molten mix to pass through a extrusion tool forming the shape of an extruded object, the extruded object including at least the body having at least three integrated rails having a unibody configuration; and processing a extruded object, which includes at least cutting the extruded object to a finished product length; where the body is configured as a housing for a three-dimensional printer and the at least three integrated rails are oriented and positioned such that the three or more rails are configurable for co-operation with three or more drive systems, the three or more drive systems being attachable to three or more arms connected to an end effector; and wherein the movement of the three or more arms are balanced such that the aggregate motion contributed by each of the three or more arms provide sufficiently accurate movement of the end effector as the end effector undergoes translational movement in three-dimensional space, and the three or more arms are configured for traversing the three or more rails to cause the end effector to undergo translational motion in relation to the body, the end effector configured for extruding a filament used in the formation of a three-dimensional object formed through the extrusion of the filament as the end effector undergoes the translational motion in accordance with one or more electronic instructions.

In some aspects, the at least three integrated rails are each formed with an extruded tab.

In another aspect, a die is provided for manufacturing an apparatus with three or more rails integrally formed on a body, wherein the body and the three or more rails are extruded together as a single, integrally formed unibody element; and wherein the three or more rails are configurable for co-operation with three or more drive systems.

In this respect, before explaining at least one embodiment in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding, and are not intended as a definition of the limits of the disclosure.

Embodiments will now be described, by way of example only, with reference to the attached figures, wherein:

FIG. 1A provides a perspective view of the body, which may be of various shapes and may have a uniform cross-section, according to some embodiments.

FIG. 1B provides a perspective view of a body, which may have three integrally formed rails and the body may house drive systems; bearings; arms; and an end effector, according to some embodiments.

FIG. 2 provides a top view of the body where the body houses elements configurable for manipulating the end effector, according to some embodiments.

FIG. 3 provides a top view of the body and the rails without the elements housed within, according to some embodiments.

FIG. 4A provides a top view of an example configuration of the traversing means on rail, the example configuration in FIG. 4A having a linear-motion bearing, according to some embodiments.

FIG. 4B provides a perspective view of the example configuration, according to some embodiments.

FIG. 5A provides a top view of an example configuration of the traversing means on rail, the sample configuration in FIG. 5A including four V-groove rollers, according to some embodiments.

FIG. 5B provides a perspective view of the example configuration, according to some embodiments.

FIG. 6A provides a side perspective view of a harder gear used to indent teeth directly into the softer extruded rails, according to some embodiments.

FIG. 6B provides a side plan view of a rail with toothed tabs, according to some embodiments.

FIG. 6C provides a partial perspective view of a rail having an integrated tab, according to some embodiments.

FIG. 6D provides a partial top plan view of a rail having an integrated tab, according to some embodiments.

FIG. 6E provides a top plan view of body having three rails, each rail having an integrated tab, according to some embodiments.

FIG. 7A provides a side perspective view of a toothed belt secured to the inside of the rails, according to some embodiments.

FIG. 7B provides a side plan view of a drive system traversing a toothed belt, according to some embodiments.

FIG. 8A provides a side cross-sectional view of a sample part with a fixed cross-sectional profile, according to some embodiments.

FIG. 8B provides a side cross-sectional view of a sample part made using injection-molding manufacturing processes where a draft angle is shown, indicating that one end may be wider than another end by a sample draft angle, which in this scenario is shown to be 0.5 degrees, according to some embodiments.

FIG. 9A, FIG. 9B, FIG. 9C and FIG. 9D provide top views of various shapes for body 100, according to some embodiments. The shapes may be provided as example shapes and other shapes may be possible. As indicated in FIG. 9C and FIG. 9D, the shapes may also be open shapes, or irregular shapes, according to various embodiments.

FIG. 10A, FIG. 10B, FIG. 10C and FIG. 10D provide illustrative examples of top views of three rails, according to some embodiments. FIG. 10A provides an example top view where the three rails may be aligned properly, according to some embodiments. FIG. 10B, FIG. 10C and FIG. 10D provide example top plan views where rails may not be aligned properly, with FIG. 10B providing rails which may not be evenly spaced from the center, FIG. 10C providing rails which may not be properly spaced 120 degrees apart, FIG. 10D providing an example where the rails may not be properly facing the center.

FIG. 11A, FIG. 11B, FIG. 11C, FIG. 11D, and FIG. 11E provide example views of rails provided to illustrate some potential issues with rails. FIG. 11A is a perspective view of a configuration where the three rails are equidistant from one another and of the same height and width. FIG. 11B is a side view of the rails where the rails are all the same height. FIG. 11C is a side view of example rails where the rails are of different heights. FIG. 11D is a side view of example rails where one of the rails is leaning sideways. FIG. 11E, is a side view where the rails may be leaning in/out relative to the center of the body.

FIG. 12 is an example workflow illustrating some example steps for manufacturing, according to some embodiments.

### DETAILED DESCRIPTION

Preferred embodiments of methods, systems, and apparatus suitable for use in implementing the disclosure are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In typical injection-molding manufacturing processes, materials may be injected into molds (also known as dies) for mass-production. One of the challenges with injection-molding processes is that they require the inclusion of draft angles (an angle incorporated into a wall of a mold so that the opening of the cavity is wider than its base). Draft angles are typically included due to the nature of injection molding and issues of mold shrinkage. As a result of the inclusion of draft angles, it may be difficult to form parts that have uniform dimensions, such as rails which may be operable to carry linear-motion bearings, for example.

A challenge facing mechanical designs having a plurality of rails is the need for proper alignment, leveling, dimensions, spacing, shaping of/between the rails within a tolerable range of variance. This challenge may be evident where the bodies supporting the rails, the rails themselves, and/or elements that travel on the rails are manufactured and/or as separate objects.

Obtaining proper alignment of the rails and spacing between the rails may be time consuming and/or difficult; considerable time and resources may need to be expended to ensure that the rails function properly.

Another challenge facing mechanical designs having a plurality of rails is the difficulty encountered when producing large quantities while keeping costs economical. Currently, many designs require a number of separate parts, which may also require assembly by an end user prior to use. Separate parts may include various elements, such as beams, brackets and fasteners, and these separate parts may be damaged during shipping and/or assembled incorrectly.

Further, designs requiring a high level of precision may also generally have low tolerances for variations. For example, in the context of three-dimensional object printing, rails must be aligned such that elements may travel accurately and in synchronicity over a period of time. These factors, among others, may impact the ability for the three-dimensional object printer to be effective at fabricating objects.

The alignment of rails, especially those requiring assembly from various parts is an important factor in the cost and pricing of three-dimensional object printers. Delta-configuration three-dimensional object printers may be especially prone to issues with misalignment of rails.

There also is a need to reduce the cost and complexity of three-dimensional object printers so that they are both affordable and reliable enough for everyday use.

There may be further benefit to be able to provide designs that require minimal assembly and/or alignment, and may more easily survive shipping, especially those designed for mass-consumption by the general public. In particular, in the context of the general public, operators may not have sufficient skill and/or resources to be able to service and/or calibrate the various structural elements of the three-dimensional object printer. Further, there may be benefits related to the ability to provide high mechanical repeatability without a need for high precision components.

Where linear-motion bearings are utilized as part of a design, it may be difficult to manufacture rails using techniques such as injection molding as the injection molding of rails may require the inclusion of draft angles. For example, a challenge that arises with the inclusion of draft angles is that the rail cross section on one end will be thinner than at the other. For applications, such as for use with linear-motion bearings, such a geometry may be detrimental to proper functioning. For example, where the rails are being used in a 3D printing environment utilizing linear-motion bearings, the inclusion of draft angles may result in a gap between the rail and slider on one side, or the other side being too large to fit the linear-motion bearing.

However, in extrusion manufacturing processes, materials may be pushed or draft through a die of a desired shape/cross-section, and objects can therefore be created of a fixed cross-sectional profile.

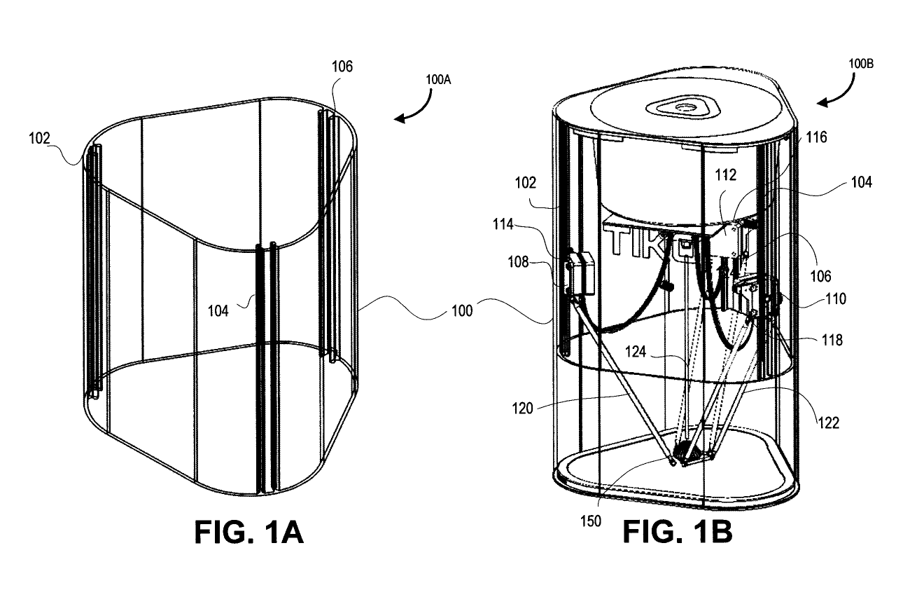

FIG. 1A and FIG. 1B provide perspective views of a body having a unibody construction, according to some embodiments.

FIG. 1A provides a perspective view of the body 100, which may be of various shapes and may have a uniform cross-section, according to some embodiments. The translucency is provided only for illustrative purposes and does not imply that the body is required to be translucent.

The body 100 may be configured as a housing for a three-dimensional printer. The body 100 may have a plurality of rails, and in this figure, three rails 102, 104, and 106 may be shown, but the number of rails may be three or more, according to various embodiments. These rails may be integral (e.g., unitary, of a singular construction, formed of a single unit, unibody) to the body 100 (e.g., free of rivets, welding, fasteners). In some embodiments, the body is adapted such that the body, along with the rails 102, 104, and 106, is provided as a single extruded part (e.g., the body has integrally formed rails, wherein the body and the associated rails are extruded together).

Integrally formed rails 102, 104, and 106 may be advantageous for: reducing the complexity arising from the inclusion of rails on bodies (e.g., less mechanical parts, reduced/potentially eliminated need for assembly/alignment of rails post-manufacturing); and ease of manufacturing (e.g., the use of extrusion processes, simplicity of shipping, reduced manufacturing cost). For example, having the body 100 and the rails 102, 104, and 106 extruded together may be advantageous for avoiding the need for the inclusion of draft angles that arises when using traditional injection molding techniques.

In some embodiments, the body 100 and the rails 102, 104, and 106 may be formed as a single, homogeneous piece, free of welds, seams, fastening, adhesives, etc. The rails may, for example, be linear rails designed for operation with various bearing and/or sliders, such as sliders using linear-motion bearings and/or various types of rollers (e.g., U groove, V groove rollers). In a specific embodiment, the three or more rails are integrally formed 102, 104, and 106 on the body 100 through extrusion as a single, unibody unit (e.g., free of welds, fastening, riveting), the three or more rails being integrally oriented and positioned relative to the body during the manufacturing of the apparatus such that an end user is able to adapt the housing for use with three-dimensional printing without requiring the user to undergo steps of additional calibration of the three or more rails.

The removal of a requirement for post-manufacturing calibration may be potentially beneficial relative to conventional three-dimensional printers, where ensuring the proper calibration and alignment of rails of a conventional three-dimensional printer that are separate (e.g., not integral or unibody) from a housing is an important, difficult, and arduous process; where small deviations may lead to downstream inaccuracies in printing and/or layer resolution. Further, these deviations may impact the stability and ability of the end effector to obtain smooth movement as it performs its tasks (e.g., extruding a filament). The need for calibration and alignment of rails drives up the cost associated with using robotics in various manufacturing and/or commercial fields, for example, with three-dimensional printing. Various techniques have been developed to address issues with calibration, for example, including an auto-levelling probe with software to help calibrate positioning, etc. A unibody housing/body may be able to reduce and/or eliminate a need for such post-manufacturing calibration and/or control systems.

In some embodiments, the body 100 and rails 102, 104, and 106 may be formed together to create a unibody/monocoque-type design. The body 100 and rails 102, 104, and 106 may be used for various tasks and/or in various configurations, such as for structural support for the components of a parallel arm robot, such as a delta robot, as described further below. In some embodiments, integrated rails 102, 104, and 106 and body 100 may also be utilized for other types of robot, such as robots having Cartesian-adapted rails, etc.

In an embodiment, the three or more rails 102, 104, and 106 are oriented and positioned such that the three or more rails 102, 104, and 106 are configurable for co-operation with three or more bearings 114, 116, and 118 (e.g., linear bearings), the three or more bearings 114, 116, and 118 being attachable to three or more arms 120, 122, and 124 connected to an end effector 150, and accordingly, the movement of the three or more arms 120, 122, and 124 are balanced such that the aggregate motion contributed by each of the three or more arms 120, 122, and 124 provide sufficiently accurate movement of the end effector as the end effector undergoes translational movement (e.g., in three dimensional Euclidean space).

The three or more arms 120, 122, and 124 may be configured for traversing the three or more bearings 114, 116, and 118, to cause the end effector to undergo translational motion (and in some embodiments, rotational motion) within (and/or relative to/extending from) the body 100 where the end effector may extrude a filament used in the formation of a three-dimensional object (e.g., formed from the layering of the extruded filament), and the translational motion is controlled in accordance with one or more electronic instructions (e.g., provided in the form of various electronic blueprints and/or instruction sets, such as STL files, Parasolids, G-Code), for example, through the use of a suitably configured control unit. For example, a G-Code file may be a collection of instructions which “slices” a three-dimensional computer-aided design model into layers and creates the tool path which the end effector will follow.

In some embodiments, the parallel arm robot may be configured for operating various tasks, such as object picking, spray painting, etching, object fabrication, robotic surgery, manipulation of various objects, performing tasks on assembly lines, etc.

FIG. 1B provides a perspective view of body 100, may have three integrally formed rails 102, 104, and 106, and the body 100 may house drive systems 108, 110 and 112; bearings 114, 116, and 118; arms 120, 122, and 124; and end effector 150, according to some embodiments.

The apparatus depicted in FIG. 1B may be an implementation for the fabrication of three-dimensional objects configured in a delta-robot design, and other implementations may be possible with other configurations, according to various embodiments.

The drive systems 108, 110, and 112 may be attached to the rails 102, 104, and 106 through their respective bearings and/or one or more sliders. The drive systems 108, 110, and 112 may be configured to use bearings and/or sliders that may be operable to traverse along the rails 102, 104, and 106. The drive systems 108, 110, and 112 may be connected to arms 120, 122, and 124, which extend outwards from the drive systems 108, 110, and 112 and may be connected to an end effector 150. In some embodiments, the drive systems 108, 110, and 112 may not necessarily be secured to the rails 102, 104, and 106 or the sliders directly, and rather, may be indirectly coupled with the sliders and/or rails 102, 104, and 106. For example, there may be implementations where a pulley-based system may be used alongside the sliders.

In some embodiments, the end effector 150 further includes an accelerometer, the accelerometer configured to capture sensory data used at least for increasing calibration of the translational motion of the end effector. The accelerometer may also be provided on the body 100. The accelerometer may be used, for example, to also detect when the body 100 is disturbed (e.g., to control the printing to stop in the event of a detected disturbance).

A drive system 108, 110, and 112 may then, for example, include a motor that may be fixed to the top of the body, and a belt that may be configured to run from the motor to a pulley and back up to the motor, which may form a closed loop, in some embodiments. In various embodiments, the belt could also be a wire, rope, or cable. Other configurations may be implemented with respect to drive systems, according to some embodiments.

The arms 120, 122, and 124 may be configured to move in synchronicity to control and/or cause the movement of the end effector 150, which may be configured to perform various tasks, such as the fabrication of objects, performing robotic surgery, painting, mixing, etching, manipulating, picking, etc. In some embodiments, there may be more or less rails, more or less drive systems, more or less bearings, more or less arms, and/or more or less end effectors.

In an example, the arms 120, 122, and 124 may be mounted to operate on the rails 102, 104, and 106, in the context of a three-dimensional printer, where the movement of the arms are synchronized and/or controlled such that precise movement of an end effector 150 is caused in relation to the extrusion of a filament (or various filaments) in the context of printing three-dimensional objects.

The drive systems 108, 110, and 112 may include various motors to control the motion of the arms 120, 122, and 124 and/or to cause the drive systems 108, 110, and 112 to traverse the rails 102, 104, and 106.

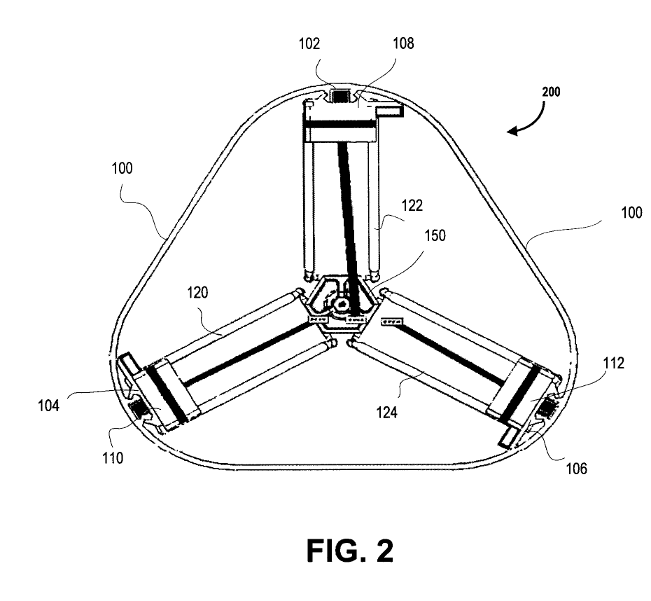

FIG. 2 provides a top view of the body 100 where the body houses elements configurable for manipulating the end effector 150, according to some embodiments. As indicated in FIG. 2, there each of the rails 102, 104, and 106, are provided in relation to a corresponding one of arms 120, 122, and 124. In some embodiments, the body 100 provides an enclosed print chamber.

The integrated aspect of the rails 102, 104, and 106 with the body 100 may be beneficial as the precision and/or accuracy of the movement of the end effector 150 may be directly associated with how the rails 102, 104, and 106 are positioned and oriented geometrically from one another. For example, the movement of the end effector 150 in three-dimensional space may be particular affected by variations in the calibration and/or configuration of the rails 102, 104, and 106, and such variations are reduced through having the rails 102, 104, and 106 integrated directly as part of a unibody, unitary element with body 100.

For example, even slight variations in the orientation of the rails 102, 104, and 106, may cause significant loss of precision, especially as the movement of the end effector 150 is provided as a combination of the position components of the arms 120, 122, and 124. This variation may be magnified, for example, as the arms 120, 122, and 124 move through various positions (e.g., an off-angle of 1 degree at a proximal end may cause a greater variance at a distal end of a rail 102). These losses in precision may, for example, impact the speed and/or control overhead associated with the activities of the body 100.

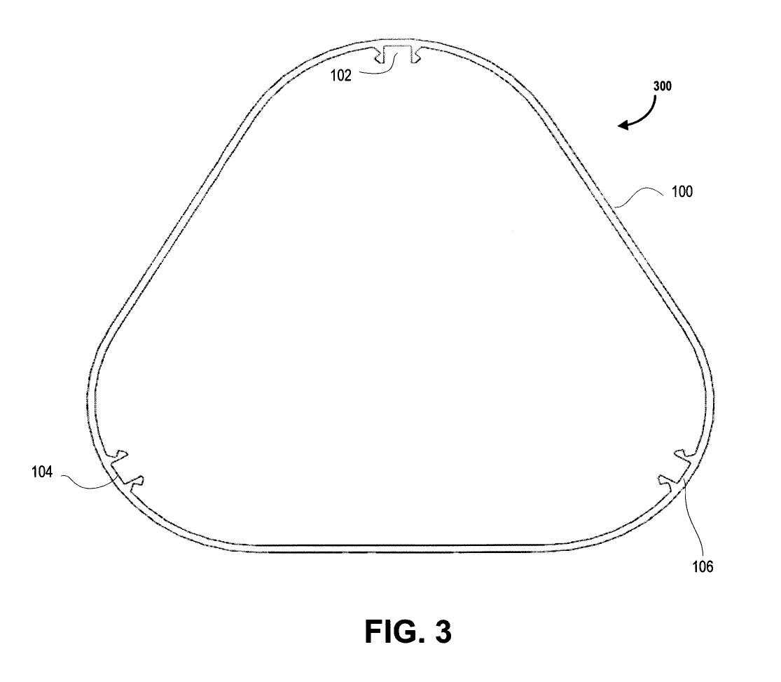

Referring to FIG. 3, FIG. 3 provides a top view of the body 100 and the rails 102, 104, and 106 without the elements housed within, according to some embodiments. In FIG. 3, for illustration, the body is shown only with the rails 102, 104, and 106.

### Parallel Arm/Delta Robotics

In some embodiments, bodies with integrally formed rails of fixed cross-sectional profiles may advantageously utilized in the context of parallel arm/delta robotics. For example, the body 100 of FIG. 1A, FIG. 1B, FIG. 2, and FIG. 3 may be used in such an application.

Parallel arm robots may include robots where a plurality of arms may cooperate with one another to control the movement of one or more end effectors in three dimensions, and potentially along 3 axes of rotation, depending on aspects of the configuration, such as the number of rails. Delta robots may be a subset of parallel arm robots wherein three sets of arms may be used that travel along three vertical rails to cause the movement of one or more end effectors.

For illustrative purposes, a delta robot may be configured with three vertical rails 102, 104, and 106, each equidistant and positioned 120 degrees from a central point, with three devices operable to traverse the vertical rails using a combination of motors and linear-motion bearings. The devices may be coupled with one or more arms 120, 122, and 124 each. These arms may be connected to an end effector 150. Through the traversal of the vertical rails 102, 104, and 106, the devices (e.g., drive systems 108, 110, and 112) may cause the arms 102, 104, and 106 to push or pull in various directions, the movement of the arms balanced to cause the movement of end effector 150 in three dimensions.

Delta robots may be used for the manipulation of light and small objects at a high speed and high level of accuracy, but delta robots may be prone to issues with alignment and/or complexity, as the synchronized movement of the arms 120, 122, and 124 may be very sensitive to design tolerances. As design tolerances widen, the level of accuracy and/or speed of the delta robots may be impacted.

In some embodiments, the apparatus may be configured as a parallel arm robot, such as a delta robot. In other embodiments, the apparatus may not be limited only to delta robots, but also to any other type of robots where there may be more than three or more rails that have devices operating in synchronicity in causing the motion of one or more end effectors.

Accordingly, in some embodiments, the designs may not be limited to having 3 120, 122, and 124 rails that are equidistant and evenly distributed around a central point. There may be implementations where it is only necessary to have the rails and their devices cause motion through adducing forces in vectors that, in combination, span the vector space that the design operates within.

For example, various designs may have 2 rails, 4 rails, 10 rails, etc., and may also have more than one end effector 150, and/or other types of attached devices. The various designs may be used for operation in two dimensional space (e.g., a flat usage), three dimensional space (e.g., in Euclidean space), and so on.

### Rail Design and Bearings

In an embodiment, the rails 102, 104, and 106 may be extruded such that the rails 102, 104, and 106 themselves are provided as inward facing protrusions, the inward facing protrusions having a shape amenable to support various bearings 114, 116, and 118, and/or drive systems 108, 110, and 112.

In some embodiments, the rails may be configurable to accommodate one or more bearing types.

In some embodiments, the rails 102, 104, and 106 may be configured for a ‘slider’ design, whereby a motor may be positioned between the rails 102, 104, and 106 in conjunction with a linear motion bearing, which may reduce torque on the slider and may reduce binding.

In some embodiments, the rails 102, 104, and 106 may be configured for a ‘slider’ design, whereby a motor may be secured to a linear motion bearing, with the drive gear being located between the rails, which may reduce torque on the slider and may reduce binding.

In some embodiments, the drive systems 108, 110, and 112 may not necessarily be secured to the rails 102, 104, and 106 or the sliders directly, and rather, may be indirectly coupled with the sliders and/or rails.

For example, there may be implementations where a pulley based system may be used alongside the sliders.

A drive system 108, 110, and 112 may then, for example, include a motor that may be fixed to the top of the body, and a belt that may be configured to run from the motor to a pulley and back up to the motor, which may form a closed loop, in some embodiments. In various embodiments, the belt could also be a wire, rope, or cable. Bearings may also be various types of groove rollers, such as U or V groove rollers.

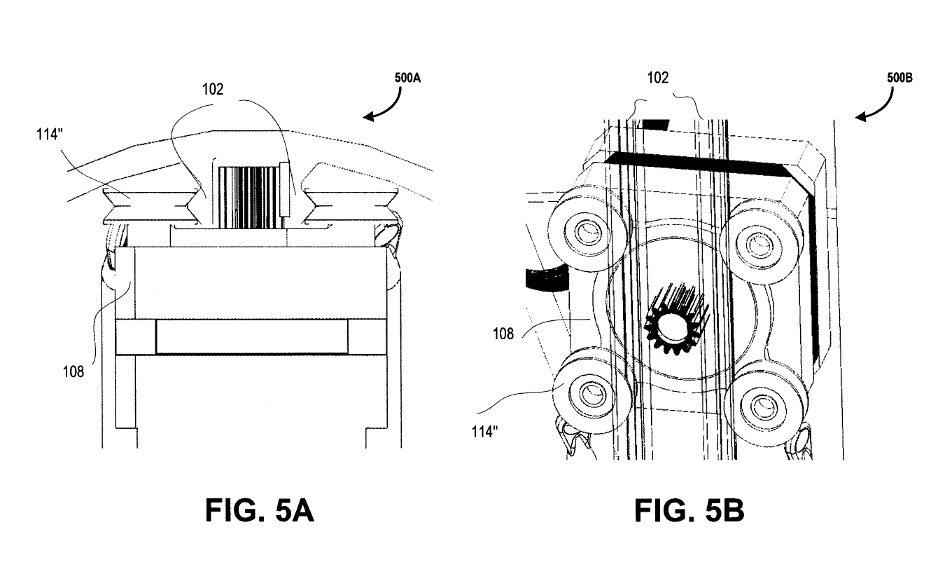

The rails 102, 104, and 106 may also be configurable, according to various embodiments, such that the rails may be in male configurations and the rollers be in female configurations, and/or vice versa. Various numbers of groove rollers may be contemplated for operability with a rail; for example, while 4 may be shown in FIG. 5B, other numbers of rollers, such as 3 rollers, may also be used. Various rail types may be considered depending on the environmental and/or operating conditions that may be encountered by the apparatus. For example, temperature, humidity, ruggedness, cost, etc., may need to be considered in designing potential configurations for the rails.

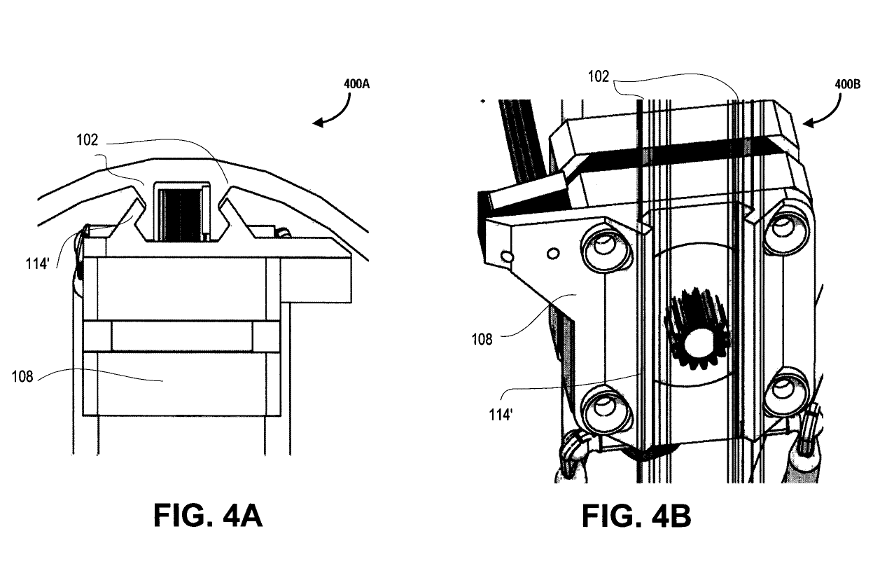

FIG. 4A provides a top view of an example configuration of the traversing means on rail 102, the example configuration in FIG. 4A having a linear-motion bearing 114′, according to some embodiments. FIG. 4B provides a perspective view of the example configuration, according to some embodiments.

FIG. 5A provides a top view of an example configuration of the traversing means on rail 102, the sample configuration in FIG. 5A being having four V-groove rollers 114″, according to some embodiments. FIG. 5B provides a perspective view of the example configuration, according to some embodiments.

### Tab System

Extruded rails 102, 104, and 106 may have a constant, smooth profile down their length, and some drive systems 108, 110, and 112 may require teeth, such as a toothed rack, to have elements traverse the rails.

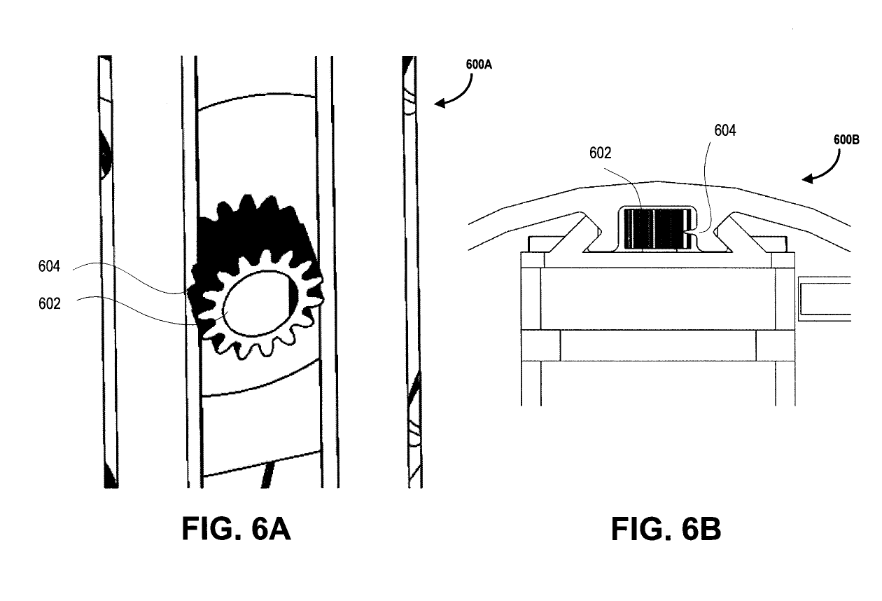

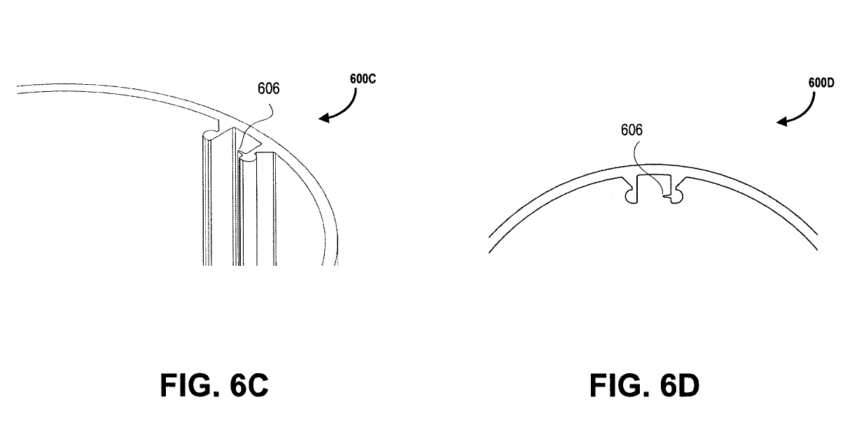

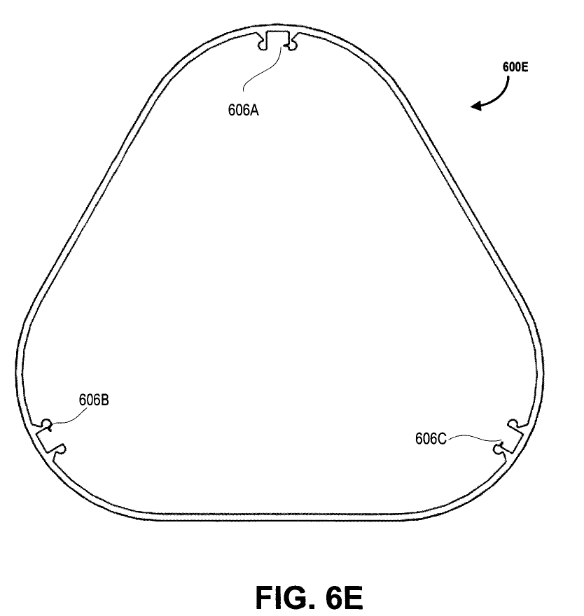

In some embodiments, a set of teeth may be indented onto an extrusion built into the rails. FIG. 6A provides a side perspective view of a harder gear 602 used to indent teeth directly into the softer extruded rails 604, according to some embodiments. FIG. 6B provides a side plan view of a rail with toothed tabs, according to some embodiments.

In some embodiments, an integrally formed tab 606 may be provided, as an extrusion manufacturing process may permit for various components to be integrated and manufactured as part of a unibody object. FIG. 6C provides a partial perspective view of a rail having an integrated tab 606, according to some embodiments, and FIG. 6D provides a partial top plan view of a rail having an integrated tab 606, according to some embodiments.

Each rail section may have an integrally formed tab 606, the integrally formed tab 606 used to serve as a gear rack which may be configured to intermesh with a pinion gear. The extruded tab 606 may, in some embodiments, include gear teeth to form a functional gear rack and pinion drive system along which the sliders/rollers may be configured to traverse (e.g., drive themselves) along (e.g., up and down) the rails.

The integrated tab 606 may be oriented in the direction of the extruded rails, thus reducing and/or eliminating any misalignment resulting from fastening, welding, riveting or otherwise attaching a gear rack onto the rails. The extruded tab 606 may be potentially advantageous in further reducing the complexity and cost arising from the inclusion multiple gear racks into the unibody design.

FIG. 6E is a top plan view of body 100 having three rails 102, 104, and 106, each rail having an integrated tab 606A, 606B and 606C, according to some embodiments.

In some embodiments, a toothed belt 702 may be secured to the inside of the rails using various securing means, such as various adhesives and/or double sided tapes. The toothed belt may be made of various materials, such as rubber, and may be beneficially configured to absorb noise, vibration and/or excessive forces.

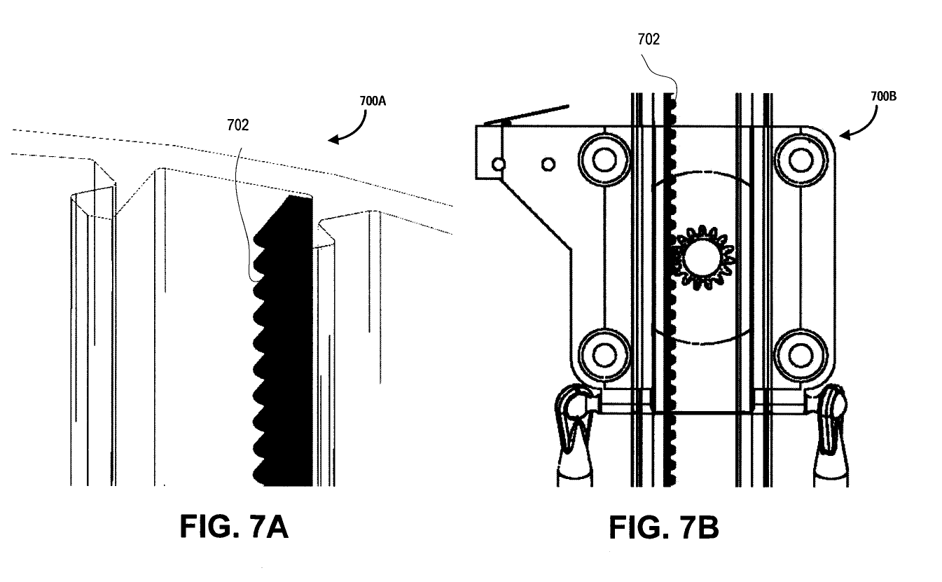

FIG. 7A provides a side perspective view of a toothed belt 702 secured to the inside of the rails, according to some embodiments. FIG. 7B provides a side plan view of a drive system traversing a toothed belt 702, according to some embodiments.

The extrusion may be, in some embodiments, a thin tab that may have a similar profile as the extruded rail. The extrusion may be made of softer material, and teeth may be indented into the softer (e.g., plastic) extrusion by using a harder corrugating means, such as a gear (e.g., hard relative to soft plastic, such as a gear made of metal) to indent teeth directly into the softer extrusion.

During operation, the extruded rails may experience lower forces, below the yield point of the material, so indentations may not be prematurely worn or inadvertently created. Where a gear is being used as a corrugating means, the gear may be slightly larger relative to a drive gear, so that the teeth may provide a better fit for use with the drive gear.

### Rail Orientation

In some embodiments, the rails 102, 104, and 106 may be configured to point inwards towards the center of the body 100. Such a configuration may be advantageous for particular implementations, such as with parallel arm robots as the connecting arms, which point inward, would otherwise interfere with the unibody itself. Inwardly pointing rails may be configured such that the mechanism of the robot operates within the bounding area of the body (e.g., the arms 120, 122, and 124 being configured to travel along the inner periphery of the body 100).

In some embodiments, the rails 102, 104, and 106 may be configured to point outwards (e.g., radially) away from the center of the body 100. For example, the arms 120, 122, and 124 may be configured to travel along the outer periphery of the body 100.

In some embodiments, the rails may be equidistant from one another.

### Fabrication of Three-Dimensional Objects

Three-dimensional object printing may be defined as the fabrication of various three-dimensional objects from a representation of the object stored in memory. There may be various configurations for three-dimensional object printing, and many three-dimensional object printers require the use of devices that traverse one or more rails and cooperate in causing the movement of one or more end effectors that extrude materials, such as filaments.

Three-dimensional object printers may be implemented having various configurations. These configurations may include Cartesian-style printers and/or delta robotics-style printers.

Cartesian-style printers may have perpendicular rails to which sliders and/or other movement means may be attached, where the sliders operate to cause movement to an end effector in x, y and z directions, whereas delta robotics-style printers may have a number of equidistant rails, relative to a central point, where the vertical motion of the movement means, such as sliders, on those rails cause movement of the end effector in various directions.

The specific context of implementing three-dimensional printing may be advantageously conducted through the use of bodies 100 with integrally formed rails 102, 104 and 106, according to some embodiments. In some embodiments, the movement of the end effector 150 may be caused by the movement of one or more arms attached to sliders, such as those coupled using linear motion bearings.

In some embodiments, the body and rails may be useful in the context of three-dimensional printing as the body may be configured for interoperability with various other components, such as a control system, various processors, various non-transitory computer readable media, various input materials, various print heads/extruders, and/or various interface circuitry. Further, the apparatus may also be used in conjunction with various software, firmware and/or other hardware.

### Draft Angles

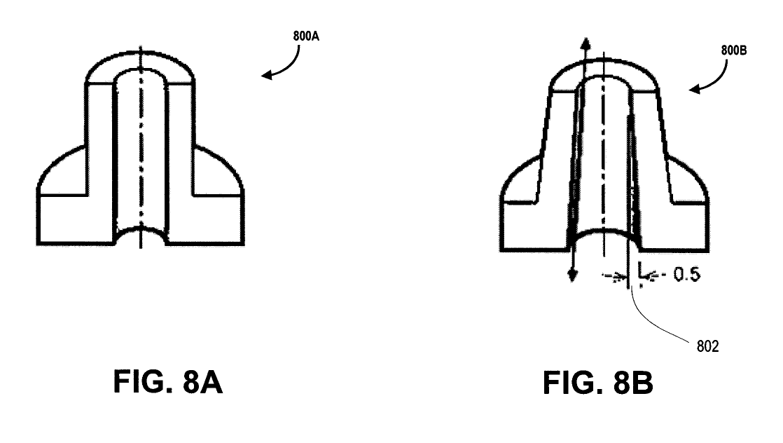

FIG. 8A and FIG. 8B are provided to illustrate draft angles that may result with injection-molded manufacturing processes. These draft angles may be undesirable, and accordingly, injection-molding may not be suitable for some embodiments. Accordingly, some embodiments advantageously utilize extrusion technology to providing the integrally formed body 100 and rails 102, 104 and 106.

FIG. 8A provides a side cross-sectional view of a sample part with a fixed cross-sectional profile, according to some embodiments. In this figure, it should be noted that the sides of the part are substantially parallel to the median line.

FIG. 8B provides a side cross-sectional view of a sample part made using injection-molding manufacturing processes where a draft angle 802 is shown, indicating that one end may be wider than another end by a sample draft angle 802, which in this scenario is shown to be 0.5 degrees, according to some embodiments.

The sample draft angle 802 is provided merely as an example, draft angles 802 may vary depending on manufacturing process and/or other variables. Accordingly, the issue of draft angles 802 as part of injection-molded processes may potentially be avoided through using extrusion instead of injection-molding the body 100 and/or the rails 102, 104 and 106.

### Alternative Shapes

Various shapes may be possible for the body 100. These shapes may be closed shapes and/or open shapes, and/or may have irregular profiles. In some embodiments, the body and the three or more rails may be shaped in a triangular prism, which may have rounded corners. In some embodiments, the body and the three or more rails may be shaped as a cylinder.

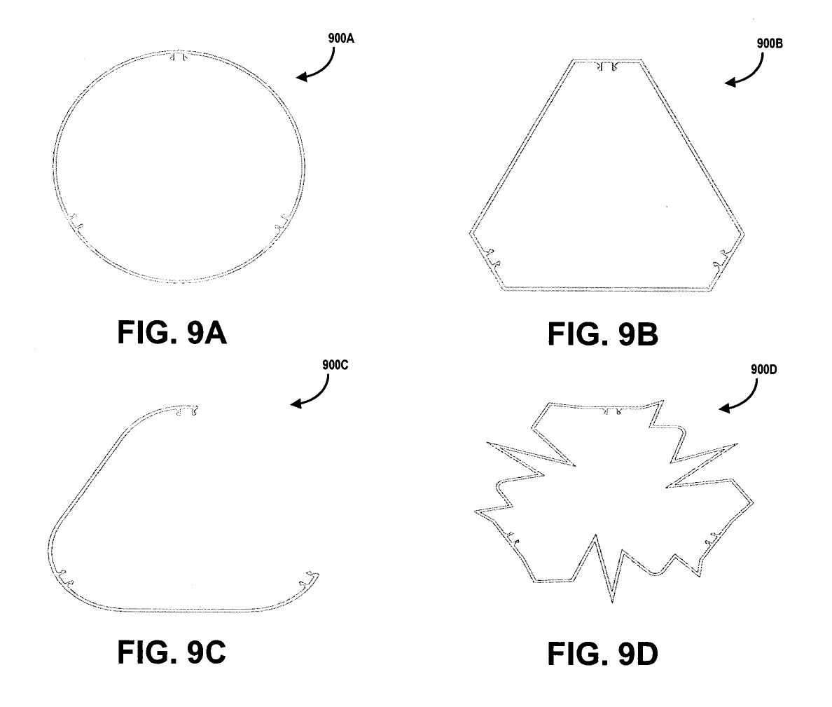

FIG. 9A, FIG. 9B, FIG. 9C and FIG. 9D provide top views of various shapes for body 100, according to some embodiments. The shapes may be provided as example shapes and other shapes may be possible. As indicated in FIG. 9C and FIG. 9D, the shapes may also be open shapes, or irregular shapes, according to various embodiments.

### Alignment of Body and Rails

As indicated above, a challenge with delta robots may be the inclusion of aligned, co-axial rails. Where the rails are provided separately, it may be difficult to ensure that they have proper alignment, leveling, dimensions, spacing, shaping of/between the rails within a tolerable range of variance.

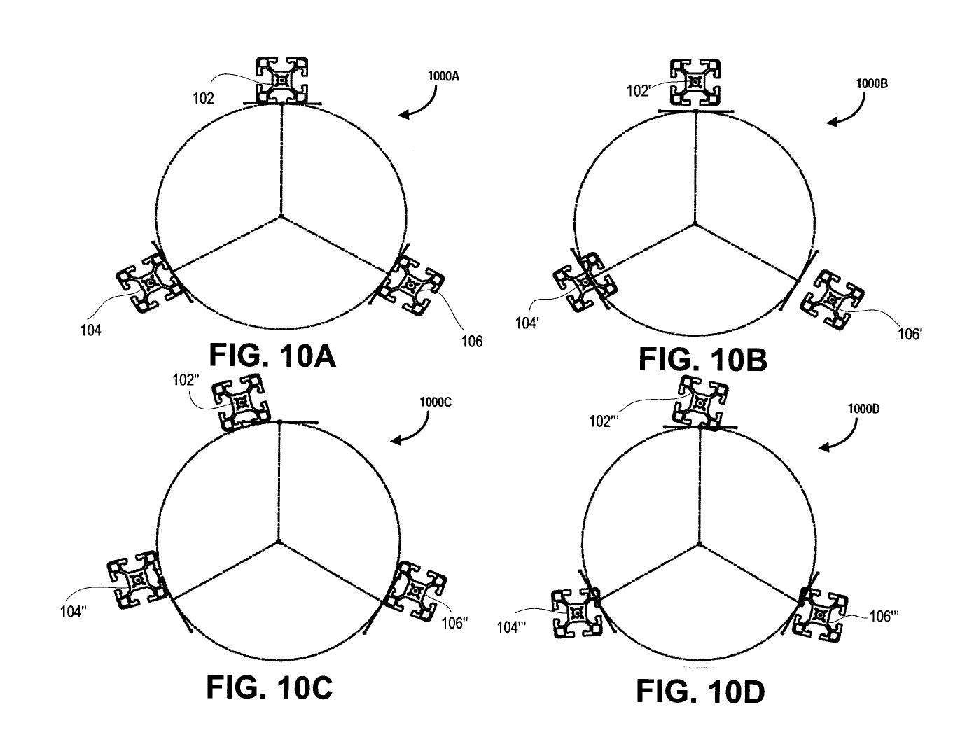

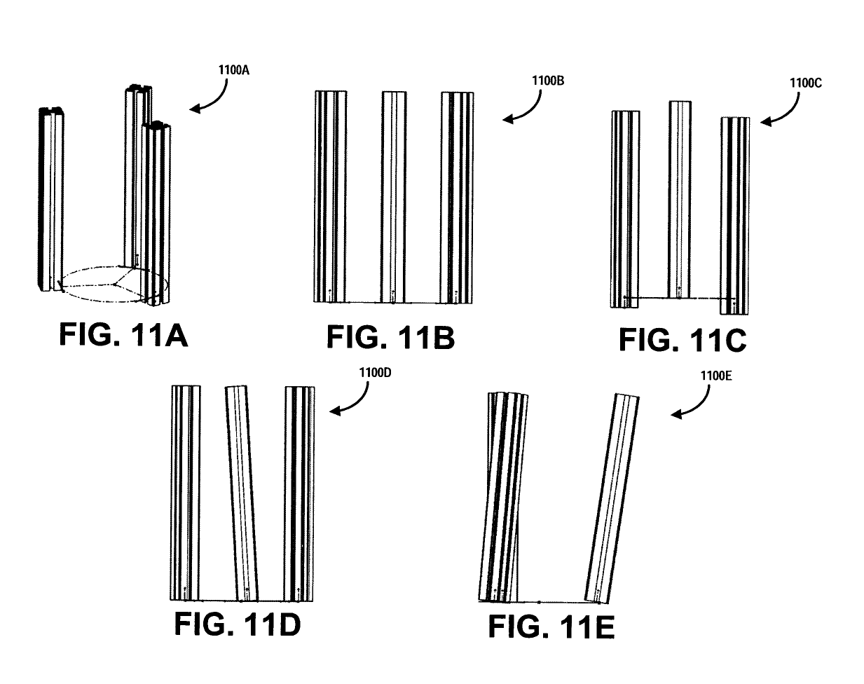

As indicated below with reference to FIGS. 10A-D and FIGS. 11A-E, there may be various alignment issues that may arise with conventional designs. A potential advantage of having integrally formed body and rails may be the potential to mitigate and/or reduce these types of issues.

FIG. 10A, FIG. 10B, FIG. 10C and FIG. 10D provide illustrative examples of top views of three rails, according to some embodiments. FIG. 10A provides an example top view where the three rails 102, 104, and 106 are aligned properly, according to some embodiments.

FIG. 10B, FIG. 10C and FIG. 10D provide example top plan views where rails are not aligned properly, with FIG. 10B providing rails 102′, 104′, and 106′ which are not evenly spaced from the center, FIG. 10C providing rails 102″, 104″, and 106″ which are not properly spaced 120 degrees apart, FIG. 10D providing an example where the rails 102′″, 104′″, and 106′″ are not b properly facing the center.

FIG. 11A, FIG. 11B, FIG. 11C, FIG. 11D, and FIG. 11E provide example views of rails provided to illustrate some potential issues with rails. FIG. 11A is a perspective view of a configuration where the three rails are equidistant from one another and of the same height and width. FIG. 11B is a side view of the rails where the rails are all the same height. FIG. 11C is a side view of example rails where the rails are of different heights. FIG. 11D is a side view of example rails where one of the rails is leaning sideways. FIG. 11E, is a side view where the rails may be leaning in/out relative to the center of the body. These may be many other possible ways that rails can be misaligned, and they can occur in combinations.

In some embodiments, a unibody/monocoque body with integrally formed rails may be provided such that the body and the three or more rails can be manufactured together as one single component. In further embodiments, the body and the three or more rails can be manufactured using an extrusion process.

The integrally formed construction may be beneficial in reducing the need for alignment and increasing the ease of mass production, especially where the various parts may be manufactured using extrusion processes, as the body and rails may have a constant cross-sectional profile. Further benefits may include the reduction of costs through the elimination of separate parts, ease of shipping, increased consistency in manufacturing output, etc.

The elimination of separate parts may be an advantageous feature in that it may be much easier to mass produce a single, unibody construction with integrated body and rails as opposed to a design made with individual beams, brackets, fasteners, rails, etc.

Further, in some embodiments, the need for assembly may be reduced, potentially saving time and money.

These factors may be particularly advantageous in the context of manufacturing for consumption by the general public, who may be cost conscious and/or do not have the skill/resources to service and/or calibrate various components of a conventional design.

### Integral Forming Using Extrusion Processes

In some embodiments, the integrally formed body 100 and rails 102, 104, and 106 may be manufactured using extrusion-based techniques.

Extrusion-based techniques may be applicable given the need for a constant cross-sectional profile, and may, in some embodiments, provide the ability to manufacture the body/rails as a singular piece, free of welds and/or other fastening means.

Extrusion-based techniques may also be cheaper or require less investment into production lines given particular economies of scale. Various techniques may be used, such as, but not limited to, direct/forward extrusion, indirect/backwards extrusion, hydrostatic extrusion, etc., and the extrusion can be done either hot, warm or cold.

For example, a long section (e.g., hundreds of feet) of the profile may be extruded, and then cut to specified lengths.

The body 100 and rails 102, 104, and 106 may be formed using various extruded materials, including various plastics/polymers such as, but not limited to, polyethylene, polypropylene, acetal, acrylic, nylon (polyamides), polystyrene, polyvinyl chloride (PVC), acrylonitrile butadiene styrene (ABS) and polycarbonate; and various metals/metal alloys, such as, but not limited to, aluminum, brass, copper, lead, tin, magnesium, zinc, steel and titanium.

The extrusion process, in some embodiments, may involve the creation of one or more dies configured to form the body and/or the rails as a single piece, free of welds and/or other fastening means. An extruded material may be pushed or drawn through the one or more dies configured in the desired cross-sections to create the body 100 and/or rails 102, 104, and 106.

A potential advantage to such an embodiment may be the ability to cheaply and quickly adapt to economies of scale, in contrast to conventional designs, which may require many separate components to be fabricated and/or assembled. There may be reductions in the need for manufacturing, transporting, aligning, and precisely fastening of the components, which may be further advantageous when shipping and/or transporting.

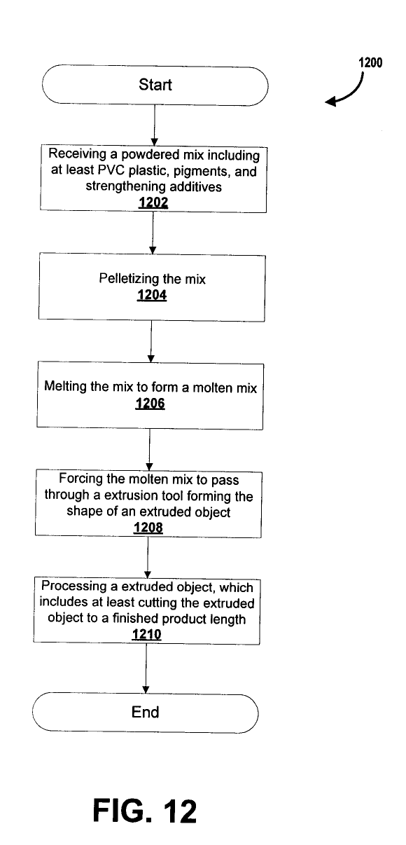

FIG. 12 is an example workflow illustrating some example steps for manufacturing, according to some embodiments. In relation to the body 100, an extrusion process may be undertaken in workflow 1200.

At 1202, a powdered mix including at least PVC plastic, pigments, and strengthening additives may be received.

At 1204, the mix may be pelletized. At 1206, the mix may be melted to form a molten mix. At 1208, the molten mix may be forced to pass through an extrusion tool forming the shape of an extruded object, the extruded object including at least body having at least three integrated rails having a unibody configuration.

At 1210, there may be processing in relation to the extruded object, which includes at least cutting the extruded object to a finished product length; where the body is configured as a housing for a three-dimensional printer and the at least three integrated rails are oriented and positioned such that the three or more rails are configurable for co-operation with three or more drive systems, the three or more drive systems being attachable to three or more arms connected to an end effector; and wherein the movement of the three or more arms are balanced such that the aggregate motion contributed by each of the three or more arms provide sufficiently accurate movement of the end effector as the end effector undergoes translational movement in three-dimensional space, and the three or more arms are configured for traversing the three or more rails to cause the end effector to undergo translational motion in relation to the body, the end effector configured for extruding a filament used in the formation of a three-dimensional object formed through the extrusion of the filament as the end effector undergoes the translational motion in accordance with one or more electronic instructions.

As the extrusion process may introduce surface scratches and imperfections, a buffing and polishing process may be utilized in relation to a metal extrusion tool.

In some embodiments, an extruded tab may also be included integrated on to the unibody object, and there may be steps of cutting and/or other processing to form the gear rack from the extruded tab integrated into the unibody object.

The above steps are described as illustrative non-limiting examples, and other, different, and/or alternate steps may be undertaken.

### General

It will be appreciated by those skilled in the art that other variations of the embodiments described herein may also be practiced. Other modifications are therefore possible.

Although the disclosure has been described and illustrated in exemplary forms with a certain degree of particularity, it is noted that the description and illustrations have been made by way of example only. Numerous changes in the details of construction and combination and arrangement of parts and steps may be made.

Except to the extent explicitly stated or inherent within the processes described, including any optional steps or components thereof, no required order, sequence, or combination is intended or implied. As will be understood by those skilled in the relevant arts, with respect to both processes and any systems, devices, etc., described herein, a wide range of variations is possible, and even advantageous, in various circumstances.

1. An apparatus comprising:
a body configured as a housing for a three-dimensional printer;
three or more rails integrally formed on the body;
wherein the three or more rails are oriented and positioned such that the three or more rails are configurable for co-operation with three or more drive systems, the three or more drive systems being attachable to three or more arms connected to an end effector;
wherein the movement of the three or more arms are balanced such that the aggregate motion contributed by each of the three or more arms provide sufficiently accurate movement of the end effector as the end effector undergoes translational movement in three-dimensional space, and the three or more arms are configured for traversing the three or more rails to cause the end effector to undergo translational motion in relation to the body, the end effector configured for extruding a filament used in the formation of a three-dimensional object formed through the extrusion of the filament as the end effector undergoes the translational motion in accordance with one or more electronic instructions; and
wherein the three or more rails are integrally formed on the body through extrusion as a single, unibody unit, the three or more rails being integrally oriented and positioned relative to the body during the manufacturing of the apparatus such that an end user is able to adapt the housing for use with three-dimensional printing without the end user undertaking additional steps of calibrating the three or more rails.

2. The apparatus of claim 1, further comprising a control unit configured for controlling the operation of the three or more drive systems and the operation of the end effector in accordance with the one or more electronic instructions.

3. The apparatus of claim 1, wherein the end effector further includes an accelerometer, the accelerometer configured to capture sensory data used at least for increasing calibration of the translational motion of the end effector.

4. The apparatus of claim 1, wherein the three or more rails are configured to support the three or more arms projecting downwards from the three or more rails, suspending the end effector in positions below the three or more rails.

5. The apparatus of claim 1, wherein the three or more drive systems are configured for cooperation with three or more linear bearings.

6. The apparatus of claim 1, wherein the three or more drive systems are configured for cooperation with three or more roller bearings, each one of the three or more roller bearings having one or more grooves.

7. The apparatus of claim 1, wherein the three or more rails face towards the center of the body.

8. The apparatus of claim 1, wherein the three or more rails face radially outwards relative to the center of the body.

9. The apparatus of claim 1, wherein the three or more rails have equal lengths.

10. The apparatus of claim 1, wherein the three or more rails are substantially aligned in the same direction.

11. The apparatus of claim 1, wherein the three or more rails are equally spaced around the circumference of the body.

12. (canceled)

13. (canceled)

14. (canceled)

15. The apparatus of claim 1, wherein the body only includes three rails, and the three rails are spaced equidistant to one another.

16. (canceled)

17. (canceled)

18. The apparatus of claim 1, wherein each rail of the three or more rails includes a toothed belt.

19. The apparatus of claim 18, wherein each toothed belt is secured to the inside of a corresponding rail using a fastener.

20. The apparatus of claim 18, wherein each toothed belt includes at least materials having noise and vibration dampening properties.

21. The apparatus of claim 1, wherein each rail of the three or more rails includes an integrated toothed tab.

22. The apparatus of claim 21, wherein the integrated toothed tab is configured to be utilized as a gear rack for interconnection with a pinion gear, providing a rack and pinion drive system along which the drive systems may be configured to traverse along the three or more rails.

23. A method for manufacturing an apparatus with two or more rails integrally formed on a body, the method comprising:
receiving a powdered mix including at least PVC plastic, pigments, and strengthening additives;
pelletizing the mix;
melting the mix to form a molten mix;
forcing the molten mix to pass through a extrusion tool forming the shape of an extruded object, the extruded object including at least a body having at least three integrated rails having a unibody configuration; and
processing a extruded object, which includes at least cutting the extruded object to a finished product length;
where the body is configured as a housing for a three-dimensional printer and the at least three integrated rails are oriented and positioned such that the three or more rails are configurable for co-operation with three or more drive systems, the three or more drive systems being attachable to three or more arms connected to an end effector; and
wherein the movement of the three or more arms are balanced such that the aggregate motion contributed by each of the three or more arms provide sufficiently accurate movement of the end effector as the end effector undergoes translational movement in three-dimensional space, and the three or more arms are configured for traversing the three or more rails to cause the end effector to undergo translational motion in relation to the body, the end effector configured for extruding a filament used in the formation of a three-dimensional object formed through the extrusion of the filament as the end effector undergoes the translational motion in accordance with one or more electronic instructions.

24. The method of claim 23, wherein the at least three integrated rails each are formed with an extruded tab.

25. A die for manufacturing an apparatus with three or more rails integrally formed on a body, wherein the body and the three or more rails are extruded together as a single, integrally formed unibody element; and wherein the three or more rails are configurable for co-operation with three or more drive systems.
